(19) United States
(12) Patent Application Publication
(10) Pub. No.: US 2015/0304175 A1
(43) Pub. Date: Oct. 22, 2015

(54) BINDING OF APPLICATION AND INFRASTRUCTURE BLUEPRINTS

(71) Applicant: HEWLETT-PACKARD DEVELOPMENT COMPANY, L.P., Houston, TX (US)

(72) Inventors: Stephane Herman Maes, Fremont, CA (US); Matthew Simon Newman, Santa Cruz, CA (US)

(21) Appl. No.: 14/443,875

(22) PCT Filed: Dec. 3, 2012
(86) PCT No.: PCT/US12/67572

§ 371 Date: May 19, 2015

(51) Int. Cl. H04L 12/24; H04L 29/08

(52) U.S. Cl. CPC H04L 41/5054; H04L 67/10

(57) ABSTRACT

A system includes an application blueprint to characterize a given application to enable lifecycle management of the given application on a cloud. An infrastructure blueprint is provided to characterize cloud infrastructure resources on the cloud and enable lifecycle management of the cloud infrastructure resources. A binding manager binds the application blueprint and the infrastructure blueprint to generate an aggregate blueprint based on the application blueprint and the infrastructure blueprint, wherein the aggregate blueprint enables the given application to utilize an instance of provisioned cloud resources specified by the infrastructure blueprint for lifecycle management on the cloud.

### BACKGROUND

A cloud service generally refers to a service that allows end recipient computer systems (thin clients, portable computers, smart phones, desktop computers and so forth) to access a pool of hosted computing and/or storage resources (i.e., the cloud resources) and networks over a network (the Internet, for example). In this manner, the host, a cloud service provider, may, as examples, provide Software as a Service (SaaS) by hosting applications; Infrastructure as a Service (IaaS) by hosting equipment (servers, storage components, network components, etc.); or a Platform as a Service (PaaS) by hosting a computing platform (operating system, hardware, storage, and so forth).

A typical cloud service incurs charges on a demand basis, is managed by the cloud service provider and may be scaled (scaled according to desired storage capacity, processing power, network bandwidth and so forth) by the end user. The cloud service may be a public service (an Internet-based service, for example) that is generally available to all potential users or a limited access private service that is provided over a private network (a business enterprise network, for example) as well as a managed cloud service (e.g., on premise or hosted as a virtual private cloud service) or a hybrid cloud service (a cloud service that is a combination of the above). Traditionally, when a user orders a cloud service, the user may manually perform various actions related to deploying and configuring software associated with the ordered cloud service (e.g. deployment of virtual machines (VMS), middleware, application software, application components, and so forth) on the provisioned/instantiated infrastructure.

### BRIEF DESCRIPTION OF THE DRAWINGS

FIG. 1 illustrates an example system to facilitate lifecycle management of application and infrastructure via binding of service and application blueprints.

FIG. 2 illustrates an example system to facilitate lifecycle management of application and infrastructure via binding of multiple service and application blueprints.

FIG. 3 illustrates an example system for utilizing aggregate application blueprints and managing application and infrastructure lifecycles.

FIG. 4 illustrates a flowchart of an example method to facilitate lifecycle management of application and infrastructure via binding of service and application blueprints.

### DETAILED DESCRIPTION

Systems and methods are provided to enable specification of application and infrastructure requirements for execution in a cloud environment while utilizing lifecycle management processes. Application requirements can be specified via an application blueprint that specifies the components of an application along with lifecycle conditions that quantify execution and operation of the application over its lifetime. An infrastructure blueprint can be similarly specified to characterize infrastructure resources in the cloud in a manner that is segregated from the given application. Each of the blueprints can include metadata that describes capabilities and requirements of the given application and the infrastructure. A binding manager can then combine (e.g., dynamically bind or manually bind in response to a user input) the application blueprint with the infrastructure blueprint to generate an aggregate blueprint. The aggregate blueprint can specify the application components, the underlying infrastructure to support the application components, and corresponding lifecycle conditions that cause either the application and/or the cloud infrastructure to change as the application and infrastructure change throughout its respective lifetime.

Matching between infrastructure and application components can be performed manually or via algorithms that can employ policies in one example to perform matching decisions. In one example, this can include inference methods where requirements in the application level are tagged associated to components that support them in a library of infrastructure blueprints, wherein the overall infrastructure blueprint is aggregated first (before the aggregation is extended to the application, platform, and so forth.

A cloud service manager can then utilize the aggregate blueprint to provision the application and while provisioning infrastructure elements into the realized infrastructure while managing changes for the application and infrastructure over time.

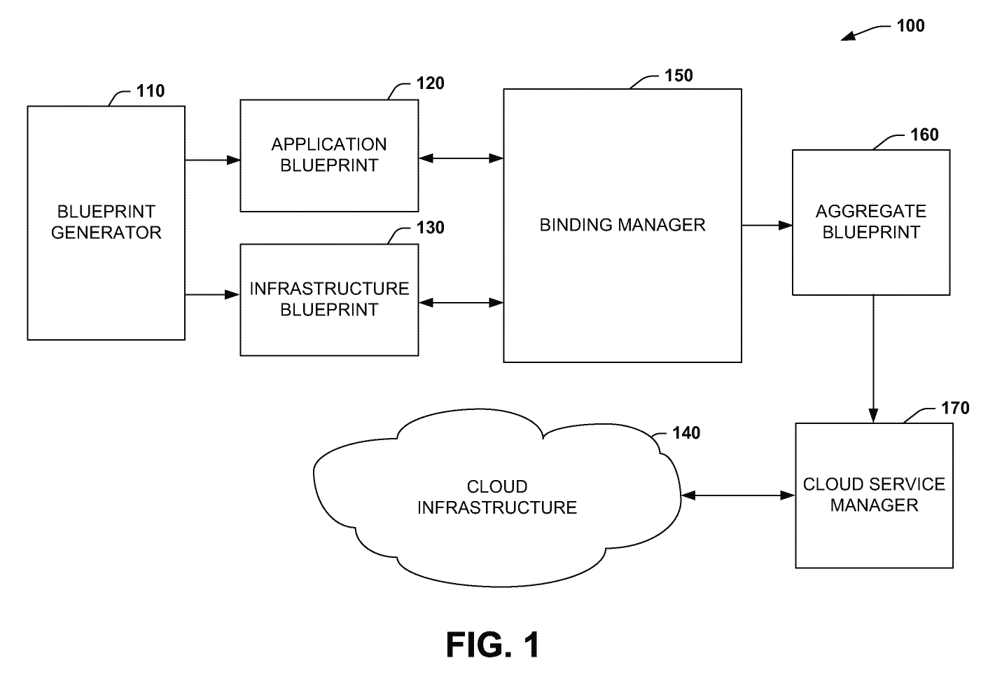

FIG. 1 illustrates an example system 100 to facilitate lifecycle management of application and infrastructure via binding of infrastructure and application blueprints. A blueprint generator 110 can be configured to create an application blueprint 120 describing components and lifecycle conditions of a given application. The blueprint generator 110 can also generate an infrastructure blueprint 130 that describes infrastructure capabilities and lifecycle conditions for operation of the infrastructure. In one example, the blueprint generator 110 can be an interface utilizing API's that enables separate creation of the application blueprint 120 and its associated components along with creation of the infrastructure blueprint 130 which specifies cloud infrastructure and lifecycle conditions for the infrastructure.

In another example, the blueprint generator 110 can be a designer. In accordance with some implementations, designers are applications that can design new recipes to build higher level services as executable or work flow/composition/business process/scripts (e.g., flows of conditions and actions) of API calls to the resource interfaces and API calls to other functions (calls to activation/provisioning service resources, for example). Moreover, new recipes may be constructed and existing recipes may be modified by the designers. It is noted that the recipes may be constructed using, for example, an API to design a script; or the construction of the recipes may be GUI-based.

In this regard, in accordance with some implementations, a designer may edit the blueprints with GUI objects representing each application, resource or service involved. The GUI links may represent the workflow (customizable conditions and actions, for example). By clicking on the object, the designer may then be able to customize each blueprint of the application, resource or service (e.g., set variables or link variables to other contexts, and so forth).

The application and associated components can be associated with an application layer which comprises all the components of the application whereas a service layer defines all the components of the infrastructure that support the application layer. Thus, the blueprint generator 110 separates specifications and requirements of the applications layer from specifications and requirements of the service layer. The separation between blueprints can be performed in two different processes. In one example, the blueprint generator 110 can consist of two designers that enforce the separation. In another case, separation can be enforced as a process and practice. In yet another case, a combination of generator based separation and practice-based separation could occur.

The application blueprint 120 characterizes a given application for deployment and to facilitate application lifecycle management on a cloud 140. The infrastructure blueprint 130 characterizes cloud infrastructure to operate the given application on the cloud 140 and to facilitate lifecycle management of the cloud infrastructure and the given application on the cloud. A binding manager 150 can generate an aggregate blueprint 160 from the application blueprint 120 and the infrastructure blueprint 130, wherein the aggregate blueprint enables provisioning of the given application to the cloud infrastructure on the cloud 140.

The binding manager 150 can operate via different methods or as a combination of methods. In one example, the binding manager 150 can be driven by a designer/user who manually binds infrastructure and application blueprints. In another example, the binding manager 150 can algorithmically bind the blueprints by matching the capabilities of infrastructure with requirements of applications. In yet another case, inference techniques (e.g., one or more trained classifiers implemented as machine readable instructions executable by a processor) can be employed to infer from the requirements of the application (that itself can consist of application, platforms, and so forth) the infrastructure blueprint components (e.g., from a library of such blueprint fragments) and combining them to become the selected infrastructure blueprint that is combined then to the applications blueprint.

In addition to or as an alternative to classifiers, inference methods (e.g., machine readable instructions executable by a processor) can include heuristic instructions that employ a heuristic match of tags between what is needed and what exists in a library, for example. This can include applying inference methods via manual binding techniques, automated binding techniques and/or combination of both (e.g., disambiguate the best match for each inference). All binding methods can utilize tags to match infrastructure to application requirements.

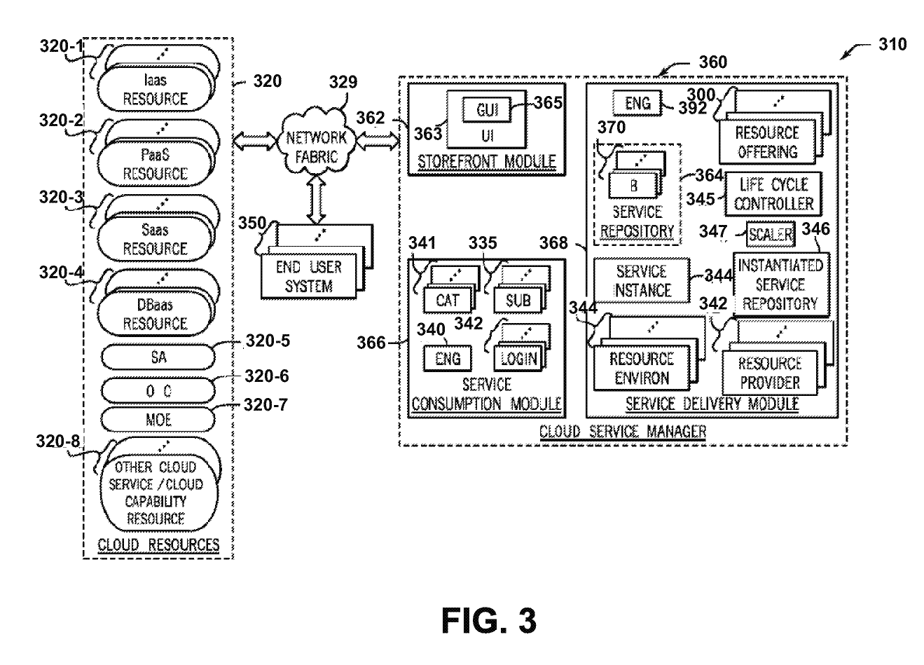

A cloud service manager 170 which is described below with respect to FIG. 3 can utilize the aggregate blueprint to initially provision the infrastructure and operate the application on the infrastructure but can also manage the application and/or infrastructure as conditions change over time (e.g., lifecycle orchestration).

In an example, conditions can be set (e.g., via policy) in the application blueprint 120 how the application should operate initially such as in a test configuration (e.g., only accept 100 messages per minute during test phase). After a selected amount of time or other condition such as load capacity, the cloud service manager 170 can enable other features/components in the given application and/or can expose the application to other infrastructure conditions. Similarly, the infrastructure blueprint 130 could specify policies for operation of the given infrastructure such as, for example, “only operate east-coast servers after midnight.” A plurality of application policies can be set and/or infrastructure blueprint policies set to define the operating conditions and infrastructure requirements over the course of the application and infrastructure lifecycle.

In another example, a lifecycle event caused by specification in one blueprint can trigger a lifecycle change in the corresponding blueprint. For example, after an application has detected that its test phase has completed, it can now trigger an operation phase for the application. Such phases can be specified in the application blueprint 120. The infrastructure blueprint 130 can be setup to adjust cloud capabilities based on detected changes in the application. For example, upon detecting a change between the testing phase and the operation phase of the application, the infrastructure blueprint 130 can specify that load balancing should be enabled on the cloud 140. This could imply the provisioning of additional servers on the cloud 140 for example as conditions change over time. Similarly, infrastructure lifecycle changes could trigger events that cause changes in the given application. For example, if an upgraded server were provisioned having higher processing speed, such event could trigger the enablement of a high-speed interrupt processing algorithm that accommodates the improved infrastructure conditions. Such conditions and events can be set via policies, for example, with the blueprint generator 110.

To support dynamic bindings in the binding manager 150, the design of infrastructure-only blueprints should be separate (e.g., segregated) from application only blueprints and can be achieved via the blueprint generator 110 that provides separate interfaces for specification of infrastructure and separate interfaces for specification of applications. The binding manager 150 in one example, can execute customer configurable and run-time resolvable best-fit algorithms between application blueprints and infrastructure blueprints, based on Quality of Service (QoS) and business policies, for example, and for substantially any resource provider, where a generic provider is guided toward a selected/instantiated infrastructure blueprint. Application blueprints 120 and infrastructure blueprints 130 can define infrastructure and application models and topologies. For example, the application blueprint 120 can specify application models defining the components of the application and conditions for execution. Similarly, the infrastructure blueprint 130 could utilize templates to define infrastructure topologies to execute the given application and mange the application over its lifecycle. Association of the infrastructure blueprints 130 to the resource pools that implement the infrastructure blueprint can be based on policies or inventory/availability of “resources in the pool” which can also be expressed as policies.

The binding manager 150 can utilize manual, inferential, and/or dynamic binding to match requirements specified in the application blueprint 120 to infrastructure specified in the infrastructure blueprint 130. For example, an application model could be specified in the application blueprint 120 which specifies all the components for execution of a given application. A resource template in the infrastructure blueprint 130 could specify all the resources available to operate the given application in the cloud 140 over the course of its lifecycle. In another example, policies could define which application components should execute in the application blueprint 120 and under what conditions the components execute over the course of their lifecycle. Similarly, policies could also specify infrastructure capability in the infrastructure blueprint 130 and how such infrastructure is to be managed over the course of its lifetime. Thus, in one example, the binding manager 150 could bind models specified in the application blueprint 120 with resource templates specified in the infrastructure blueprint 130. In another example, the binding manager 150 could bind application policies specifying application components and lifecycle conditions to policies specifying infrastructure and its conditions specified in the infrastructure blueprint 130. In yet another example, a combination of policies, models, and templates could be employed to specify the given application in the application blueprint 120 and/or the infrastructure requirements in the infrastructure blueprint 130.

Provisioning of the application and infrastructure can be achieved by selecting the different blueprints (service and application) and combining them into the aggregate blueprint 160 with the application blueprint 120 configured to use the provisioned infrastructure resource instances specified by the infrastructure blueprint. In one example, the application can be installed as the infrastructure is provisioned. In another example, the infrastructure can be provisioned and the application subsequently fitted on to the installed infrastructure. In another example, provisioning can be performed manually utilizing instructions in the aggregate blueprint 160 to provision the infrastructure and install the application accordingly.

When an application has been deployed based on matching/binding of application blueprints and infrastructure blueprints, the cloud service manager 170 further can manage other aspects of the lifecycle of the application. For example, the Recycle manager 170 can monitor feedback, and adjust the infrastructure resources based on such feedback. Additionally or alternatively, the lifecycle manager can dynamically adjust the application and corresponding policies based on such feedback or other detected events. Similarly, this can also include retiring older versions of application components (e.g., code, middleware (MW), databases, operating system (OS), and so forth) and installing new versions of components to enable continued deployment of the application in the cloud 140.

The cloud 140 can be a hybrid such that it can be a combination of traditional Data Centers that are made to behave like infrastructure resources, private clouds (cloud technology developed on premise), public clouds (offered by service providers and managed cloud configurations (managed on premise or in a public cloud/virtual private cloud). As used herein, the term application applies to a collection of components. In addition, the application can be characterized for each of its components by a set of artifacts (e.g., installer, executable, configurations and so forth, and a set of components that are installed and interact with each other (e.g., code, middleware (MW), databases, operating system (OS), and so forth). Also, as used herein, the term determining can include compiling, enumerating, and matching.

As used herein, the term “substantially” is intended to indicate that while the function or results of the term being modified are a desired or intended result that some variation can result. In this context, for example, the term “substantially match” can describe a situation that the resulting analysis and comparison is performed to identify one or more application blueprints that are configured to use the provisioned infrastructure resource instances. Where more than one such set of resources might correspond to a match, the cloud service manager 170 can select a suitable matching set of available resources. For example, the cloud service manager 170 can employ a run-time resolvable best-fit algorithm, such as based on quality of service and associated business policies, for a given resource provider. Other approaches for selecting such match can be utilized such as selection by the user to disambiguate the choice or a policy algorithm to break the ties or heuristics, and so forth.

The application blueprint 120 can be employed to characterize a given application for deployment on the cloud 140, such as though metadata descriptions for various components of the application. The cloud service manager 170 can be implemented via instructions executable or data readable by a processor to analyze an application requirement for the given application based on the application blueprint 120 and a policy (or policies) associated with the given application. In one example, the policy can be provided to describe additional operating context for the application (e.g., operate application after midnight, use only east coast servers, maintain load balancing between servers, deploy within a given network domain, ensure load is between specified limits on servers, ensure there are no upcoming maintenances within a given window, and so forth as well techniques to “measure closeness” of the matches). The lifecycle manager 170 can then determine infrastructure resources in the cloud 140 sufficient to fulfill the application requirement of the application as specified by the application blueprint 120 and policy.

Infrastructure capabilities of the cloud 140 can be determined via resource offerings and metadata associated with the cloud. For instance, a plurality of service providers supporting the cloud 140 can provide files that specify what types of resources they have available and metadata that describe properties of interest for the respective resource offerings (e.g., resource offering of three servers available with metadata specifying memory size and processor speeds, load (if already instantiated), location, tenancy terms, service level agreements (SLAs), scheduled maintenances, and so forth).

In one example, the cloud service manager 170 can automatically deploy the given application on the cloud 140 after the matching of application requirements of the application blueprint 120 to the capabilities of the cloud as specified by the resource offerings and metadata which can be specified via the infrastructure blueprints 130. In this type of example, it usually amounts to executing the instructions of other following examples described below (possibly by calling external systems that manage the lifecycle of the infrastructure and/or of the applications). As noted previously, the term application can include a set of components that are to be installed and executed (e.g., multiple tiered logic, user interface (UI), middleware (MW), database (DB), operating system (OS) in addition to the code to install and configure such components). Thus, the application refers to these sets of components and artifacts which can also include repositories of such components and artifacts. The application can also be identified by pointers to the components and artifacts including individual pointers or pointers to a set of components. In another example.

As noted above, the cloud service manager 170 can employ closed feedback loops for monitoring applications and/or infrastructure. Such monitoring can be based on policy such as to scale up or scale down an application execution requirement, for example, as well as to notify appropriate recipients, such as users or system applications. In one example, listeners can be installed in various components to capture events from monitoring. Events received by listeners can trigger handlers that can generate lifecycle management operations on the system (e.g., scale up, scale down, move, de-provision, alert user or system, run another executable that may involve composition of the systems described herein and other applications, and so forth).

The system 100 can be implemented on one or multiple hardware platforms, wherein the modules in the system can be executed on one or across multiple platforms. Such modules can run on cloud technology (various forms/and hybrid clouds) or offered as a SaaS (Software as a service) that can be implemented on or off the cloud. Complex applications can be automatically deployed on required infrastructure without also requiring users to understand how to perform such operations. Policies provide automated instructions for operating guidelines that help administrators mitigate deployment errors. Metadata can also be associated with the application by identifying the type of application (e.g., via UI or API), then the user does not need to understand the application characteristics. This approach allows “best practice”, recommended or imposed deployment models for applications based on their association to metadata. Policies also allow separating the application characteristics from other contextual considerations (e.g., about user, about application, about infrastructure, about context, about that specific user, about that specific application, and so forth. This facilitates the reuse of the application components across numerous applications. Particularization can also be achieved via policies. This is also how for example the system impose that a specific set of characteristic values are fixed for a given application or version. For example, the system could apply a generic application model for web applications, yet in another case, explicitly specify a different model or certain values for the attributes of the model. Resources can also be provided from hybrid clouds (e.g., some resources provided from local databases and servers and some resources provided from Internet services).

For purposes of simplification of explanation, in the example of FIG. 1, different components of the system 100 are illustrated and described as performing different functions. However, one of ordinary skill in the art will understand and appreciate that the functions of the described components can be performed by different components, and the functionality of several components can be combined and executed on a single component. The components can be implemented, for example, computer executable instructions, hardware (e.g., an application specific integrated circuit or a processing unit), or as a combination of both. In other examples, the components could be distributed among remote devices across a network.

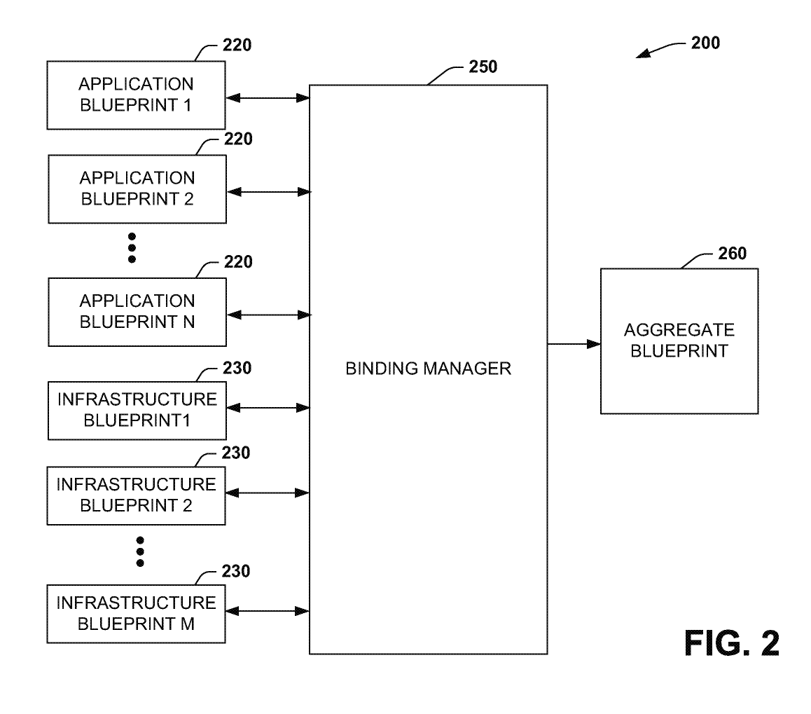

FIG. 2 illustrates an example system 200 to facilitate lifecycle management of application and infrastructure via binding of multiple service and application blueprints. In this example, multiple application blueprints 220 which are labeled 1 though N, with N being a positive integer, can be combined with multiple infrastructure blueprints 230 which are labeled 1 though M, with M being a positive integer. A binding manager 250 combines specifications from the application blueprints 220 with specifications from the infrastructure blueprints 230 to form an aggregate blueprint 260. As noted above with respect to FIG. 1, a cloud service manager can utilize the aggregate blueprint 260 to install applications specified by the application blueprints 220 on provisioned resources specified by the infrastructure blueprints 230.

In one example, a many-to-many mapping is possible, wherein multiple applications which work in concert are mapped to multiple service infrastructure configurations. In another example, a many-to-one mapping is possible, where multiple application blueprints specify multiple applications that are subsequently mapped to a single infrastructure configuration. In yet another example, one-to-many mapping is possible where a single application blueprint 220 is mapped to multiple infrastructure blueprints that are combined to provide the aggregate blueprint for provisioning of corresponding infrastructure resources for the given application. Such mappings can be set via policy configurations in the respective blueprints or via other techniques such as application model settings and/or topology template configurations. As noted above, inferential techniques can be employed wherein trained classifiers infer infrastructure configurations based on application specifications and/or requirements.

FIG. 3 illustrates an example system 310 for utilizing aggregate application blueprints and managing application and infrastructure lifecycles. Referring to FIG. 3, in accordance with systems and techniques that are disclosed herein, a cloud service manager 360 offers and delivers (instantiates, provisions and deploys, for example) services and applications to manage the lifecycles (e.g., manage the building, ongoing management, reporting, metering, reporting and so forth) of existing cloud services and combinations of these existing cloud services and applications for end users. More particularly, as disclosed herein, the cloud service manager 360 employs one or more aggregate blueprints to orchestrate the use of application programming interfaces (APIs) of existing cloud services for managing the lifecycles of the existing cloud services and combinations of the existing cloud services for users of user end systems 350 (desktops, portable computers, smart phones, clients, thin clients, servers, and so forth).

Depending on the particular implementation, the selection and ordering of the cloud lifecycle management services may be performed by a given user (an administrator, for example) for a group of end users (users of an enterprise, for example); or the selection and ordering of the cloud capabilities may be performed by a given user (an Internet-based user or employee, for example) for the given user's individual use.

As depicted in FIG. 3, the cloud service manager 360 may be accessed by a given end user system 350 via network fabric 329 (network fabric formed from one or more of local area network (LAN) fabric, wide area network (WAN) fabric, Internet fabric, and so forth). As such, depending on the particular implementation, the cloud service manager 360 may reside on an Internet server, reside on a server within a private LAN, reside on a server within a WAN, reside on a desktop computer, or may be a web or SaaS (Software as a service), as just a few examples.

In general, the users of the cloud service manager 360 may select and order “cloud capabilities” through the cloud service manager 360. In general, the “cloud capabilities” refer to user-selected combinations of existing cloud services and/or applications that are provided by existing cloud resources 320, as well as lifecycle management services that are offered and delivered by the cloud service manager 360. All of these cloud capabilities (the existing cloud services, the combinations of the existing cloud services and the lifecycle management services) are generally referred to herein as “cloud capabilities” herein. The cloud capabilities are, in general, associated with services that are associated with a “cloud,” which may be, as examples, a public cloud (a cloud formed from an Internet-based network and provides hosted cloud services that are generally available to members of the public); a private cloud (a cloud formed from a private, limited access network, (such as an enterprise network) which provides hosted cloud services to a limited group of members); a virtual private cloud (a cloud formed from a public network providing hosted cloud services to a limited group of members); a hybrid cloud (a cloud formed from a combination of two or more of the aforementioned clouds); and so forth.

In general, the cloud service manager 360 contains a storefront or marketplace module 362 that, through its user interface 363, allows a user to access a service consumption module 366 (of the cloud service manager 360) for purposes of browsing and selecting offered cloud capabilities. Moreover, through the access to the service consumption module 366, users may further customize (e.g., configure, for example) details of the selected cloud capabilities; agree to terms and/or conditions for receiving the selected cloud capabilities; order the cloud capabilities (subscribe to the capabilities, pay for the capabilities, and so forth); potentially build or modify a “recipe”, specifying a way to combine multiple cloud capabilities or provide lifecycle management; subsequently update the cloud capability selection(s); scale up and scale down the cloud capabilities; and in general, manage the if of the ordered cloud capabilities and applications, including retiring the capabilities and/or applications.

To facilitate this user selection and control, the service consumption module 366 contains one or multiple cloud service catalogs 341 (depending on the particular implementation) and/or different views of the same catalog(s) 341, which describe available cloud capabilities. The catalog 341 itself may be a federation or aggregation of catalogs. The users may browse through the catalog(s) 341 using, for example, a graphical user interface (GUI) 365 of the interface 363. In accordance with some implementations, the service consumption module 366 may contain one or more APIs/interfaces for purposes of permitting users to browse through the catalog(s) 341 using the GUI 365. It is noted that different users may have access to different catalog(s) 341 for different views of the catalog(s) 341 (different content or different commercial terms), depending on the agreement/subscription in place. By accessing the service catalog(s) 341, users may select, order, customize and combine cloud capabilities; and automate the instantiation and configuration of selected cloud capabilities.

More specifically, in accordance with example implementations, via the service consumption module 366, users may select combinations of various existing cloud resources 320 to form a selected set of cloud services and, in general, set up a service to manage the lifecycle of this combination for a given user or group of users. As examples, the existing cloud resources 320 may include such resources as an Infrastructure as a Service (SaaS) resource 320-1 (a resource that provides hosted equipment, such as servers, storage components and network components as a service); a Platform as a Service (PaaS) resource 320-2 (a resource that provides a hosted computing platform such as an operating system, hardware, storage, and so forth); a Software as a Service (SaaS) resource 320-3 (a resource that provides hosted applications as a service); a Database as a Service (DBaaS) resource 320-4 (a resource that provides a hosted database as a service); and so forth.

The available existing cloud resources 320 further include, in accordance with example implementations, resources 320 that provide other services that may be useful for the cloud, such as (as examples), resources 320-5, 320-6 and 320-7 that provide services derived from their provisioning using the Server Automation (SA), Database Middleware Automation (DMA), Matrix Opera g Environment (MOE), or Operations Orchestration (OO) software available from Hewlett Packard® and other any other infrastructure provisioning or IaaS provisioning system. Thus, in general, the cloud resources may include these as well as other cloud services/capabilities 320-8, in accordance with further implementations.

It is noted that one or multiple of the existing cloud resources 320 may be provided by the cloud service manager 360, in accordance with example implementations. In accordance with exemplary techniques and systems that are disclosed herein, users may access the catalog(s) 341 to select and order one or more of the following cloud services: services provided by the existing cloud resources 320; services provided by combinations of the existing cloud resources 320; and services to manage the lifecycle of selected services/combinations of services, including services directed to building, monitoring, metering, and reporting services. Moreover, the cloud service manager 360 allows agile development of these services, as users may configure various aspects of these services, as further described herein.

In addition to presenting the service offerings, the service consumption module 366 regulates user subscriptions to these services, in accordance with example implementations. In this manner, as depicted in FIG. 3, in addition to the catalogs 341 describing the service offerings, the service consumption module 366 may contain such other information as user login components 342 (components containing passwords, login identifications and so forth); user and tenant information; user subscription components 335 (components describing subscription contract terms, subscription rates, and so forth); and an engine 340 that contains logic that allows access and modification to the offered services, updating of subscription data, updating of login information and so forth.

The cloud service manager 360 contains a service delivery module 368 to deliver services that are described in the catalogs 341 and are selected by the users. More specifically, in accordance with example implementations, using the palette of available cloud resources and their resource offerings and actions, cloud service designers and/or administrators may utilize aggregate blueprints 370 (e.g., generated from application and infrastructure blueprints). The blueprints 370 can be stored in a service repository 364 and set forth structured plans of automated actions for instantiating and configuring the cloud capabilities and applications that are described and offered in the catalog(s) 341. Due to these pre-existing aggregate blueprints 370, logic of an engine 392 of the service delivery module 368 may automatically undertake the actions to instantiate and provision the selected cloud resources and selected application, thereby avoiding manual actions by the users pertaining to instantiation and configuration of the selected cloud capabilities.

In accordance with example implementations, the aggregate blueprint 370 can include a set of workflows/recipes/scripts that correspond to particular lifecycle management actions that may be performed to orchestrate the APIs of the appropriate cloud resources and/or applications for purposes of managing the lifecycle of a given cloud capability. In this regard, the actions are workflows and calls to resource offering interfaces, in accordance with some implementations. In accordance with example implementations, designers/administrators may use GUIs of the service delivery module 368 to orchestrate/compose multiple such aggregate blueprints 370 into aggregate blueprints 370 of new cloud capabilities.

The designers/administrators may also use GUI-based tools of the service delivery module 368 to modify existing aggregate blueprints 370 and form new aggregate blueprints 370 based on combinations of existing aggregate blueprints 370. In addition to selecting pre-existing aggregate blueprints 370, in accordance with some implementations, the service delivery module 368 may permit users to construct aggregate blueprints 370, modify existing aggregate blueprints 370, and/or create new aggregate blueprints 370 from a combination of existing aggregate blueprints 370. Users may also create and manage application and infrastructure blueprints for generating new aggregate blueprints.

As a further example, each aggregate blueprint 370 can be an object (objects formed from machine executable instructions, that performs various actions, or functions, that may be taken in connection with an associated offered cloud capability, or service) and has an associated collection of functions, or “recipes,” which may be executed to cause the orchestration of the appropriate cloud service APIs to provision, instantiate and build a cloud service (formed from one or more existing cloud services and/or applications, for example); manage a cloud service; monitor a cloud service; meter a cloud service; and so forth. A recipe can be a script or workflow or any other executable, in accordance with example implementations, which may be executed by logic of the engine 392 of the service delivery module 368 for purposes of performing the actions specified by the aggregate blueprint 370.

In accordance with example implementations, the infrastructure blueprints 370 may be associated with various commercial terms, such as prices; contract periods; terms associated with a service level agreement (SLA); and so forth, which are stored in subscription components 335 of the service composition module 366. A service becomes a service offering when associated to these terms.

These terms that accompany given infrastructure blueprints 370 may be described in the catalogs 341, in accordance with some implementations and, in general, may be set forth by a product designer.

A given aggregate blueprint 370 may be instantiated/deployed by executing its associated recipe(s), which results in service instances 344 that may be tracked by, for example, information technology (IT) management systems by feeding the service instances into an IT service management (ITSM) service, a real time service management (RTSM) service, or a configuration management database (CMDB) with a full topology of how a service instance is supported/implemented. In this manner, in accordance with example implementations, the service delivery module 368 may contain a service instance service management component 44 (e.g. RTSM or CMDB or ITSM (Information Service Management) for this purpose. If shared across an ITSM system, the component 344 is available for other management systems to monitor and manage separately the instantiated instances (identified and tracked based on topology information stored in the database). In accordance with some implementations, the actions to set up the monitoring and management are achieved through the use of the aggregate blueprints 370.

A given aggregate blueprint 370 may further specify actions that are taken to handle errors associated with given composition cloud service are handled and actions that taken to report such errors. In general, other aggregate blueprints 370 may specify how the lifecycle of a given service composition is monitored and managed during the full lifecycle of the service. For example, a given recipe may notify the owner of the system (the owner of the cloud resources 320, for example) about an error; repeat faulty steps with the same or other resource in a pool; track issues and trace back steps and tear down some of the instantiated resources/services; and so forth.

A given aggregate blueprint 370 may also describe a structured plan for usage metering and/or reporting. For monitoring, the instance and monitoring service may be setup/configured to perform the monitoring tasks; or, alternatively, a CMDB/RTSM may be in place to let a monitoring suite such as ITSM (as an example) to automatically discover and monitor. The meeting and reporting may be performed in a similar manner by setting up the meeting/reporting and adding probes or counters that allow meetings (measured CPU usage, time used, memory used, or traffic used per component by using a monitoring system to interact with agents or configuring service scalable to do so to generate charging data records (CDRs) for their use and provide them to metering systems). Reporting may be accomplished by inquiring the monitoring and/or metering management systems.

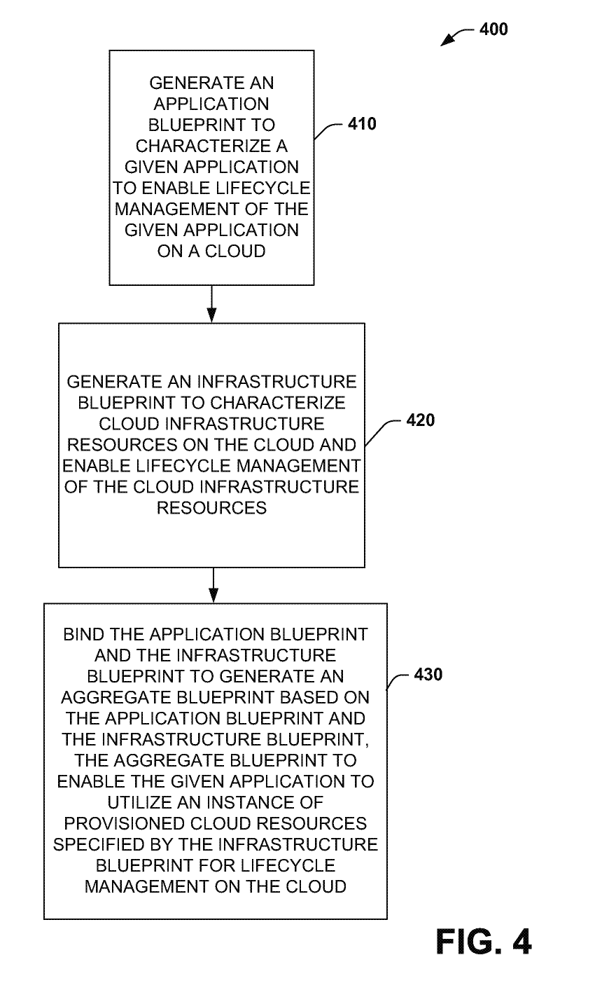

In view of the foregoing structural and functional features described above, an example method will be better appreciated with reference to FIG. 4. While, for purposes of simplicity of explanation, the example method of FIG. 4 is shown and described as executing serially, it is to be understood and appreciated that the present examples are not limited by the illustrated order, as some actions could in other examples occur in different orders and/or concurrently from that shown and described herein. Moreover, it is not necessary that all described actions be performed to implement a method. The example methods of FIG. 4 can be implemented as machine-readable instructions that can be stored in a non-transitory computer readable medium, such as can be computer program product or other form of memory storage. The computer readable instructions corresponding to the method of FIG. 4 can also be accessed from memory and be executed by a processor.

FIG. 4 illustrates an example method 400 to facilitate lifecycle management of application and infrastructure via binding of service and application blueprints. The method 400 includes generating an application blueprint to characterize a given application to enable lifecycle management of the given application on a cloud (e.g., via blueprint generator 110 of FIG. 1) at 410. At 420, the method 400 includes generating an infrastructure blueprint to characterize cloud infrastructure resources on the cloud and enable lifecycle management of the cloud infrastructure resources (e.g., via blueprint generator 110 of FIG. 1). At 430, the method 400 includes binding the application blueprint and the infrastructure blueprint, by the processor, to generate an aggregate blueprint based on the application blueprint and the infrastructure blueprint, the aggregate blueprint to enable the given application to utilize an instance of provisioned cloud resources specified by the infrastructure blueprint for lifecycle management on the cloud (e.g., via binding manager 150 of FIG. 1). The method 400 can also include adjusting the given application or the cloud infrastructure based on lifecycle conditions specified in the aggregate blueprint.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A computer readable medium comprising computer readable instructions to:
generate an application blueprint to characterize a given application to enable lifecycle management of the given application on a cloud;
generate an infrastructure blueprint to characterize cloud infrastructure resources on the cloud and enable lifecycle management of the cloud infrastructure resources; and
bind the application blueprint and the infrastructure blueprint to generate an aggregate blueprint based on the application blueprint and the infrastructure blueprint, the aggregate blueprint to enable the given application to utilize an instance of provisioned cloud resources specified by the infrastructure blueprint for lifecycle management on the cloud.

2. The computer readable medium of claim 1, further comprising a cloud service manager to manage a lifecycle of the given application and the provisioned cloud resources according to aggregate instructions contained in the aggregate blueprint.

3. The computer readable medium of claim 2, wherein the aggregate instructions comprise at least one of policy descriptions, template descriptions, and model descriptions that indicate a condition for a lifecycle event to occur for the given application or the cloud infrastructure.

4. The computer readable medium of claim 3, wherein the lifecycle event comprises at least one of an application event that triggers another lifecycle event in the cloud infrastructure based on the aggregate instructions contained in the aggregate blueprint, or an infrastructure event that triggers an application event in the given application based on the aggregate instructions contained in the aggregate blueprint.

5. The computer readable medium of claim 2, wherein the cloud service manager further comprises a monitor component to monitor feedback from the given application and enable the cloud service manager to adjust the given application or the cloud infrastructure based on the feedback.

6. The computer readable medium of claim 2, wherein the aggregate instructions are employed by a user to manually provision the cloud infrastructure and manually install the given application on the provisioned cloud infrastructure in response to a user input.

7. The computer readable medium of claim 2, wherein the aggregate instructions are employed by the cloud service manager to automatically provision the cloud infrastructure and automatically install the given application on the provisioned cloud infrastructure in accordance with the aggregate instructions.

8. The computer readable medium of claim 2, further comprising inference instructions to inferentially determine cloud infrastructure based on requirements of the given application.

9. The computer readable medium of claim 1, further comprising a binding manager that employs at least one of a manual binding process, an inferential binding process, and a dynamic binding process to bind application requirements specified in the application blueprint to infrastructure requirements specified in the infrastructure blueprint, wherein the binding manager employs a tag to support at least one of the manual binding process, the inferential binding process, and the dynamic binding process.

10. The computer readable medium of claim 9, wherein the dynamic binding process is performed according to a best fit algorithm based on at least one of a quality of service estimation or a business policy.

11. The computer readable medium of claim 1, further comprising binding instructions to perform at least one of a many-to-many mapping between the application blueprint and the infrastructure blueprint, perform a many-to-one mapping between the application blueprint and the infrastructure blueprint, and perform a one-to-many mapping between the application blueprint and the infrastructure blueprint to generate the aggregate blueprint.

12. A method comprising:
generating an application blueprint, by a processor, to characterize a given application to enable lifecycle management of the given application on a cloud;
generating an infrastructure blueprint, by the processor, to characterize cloud infrastructure resources on the cloud and enable lifecycle management of the cloud infrastructure resources; and
binding the application blueprint and the infrastructure blueprint, by the processor, to generate an aggregate blueprint based on the application blueprint and the infrastructure blueprint, the aggregate blueprint to enable the given application to utilize an instance of provisioned cloud resources specified by the infrastructure blueprint for lifecycle management on the cloud.

13. The method of claim 12, further comprising adjusting at least one of the given application or the cloud infrastructure based on lifecycle conditions specified in the aggregate blueprint.

14. A system, comprising:
a memory for storing computer executable instructions associated with a computer; and
a processing unit for accessing the memory and executing the computer executable instructions, the computer executable instructions comprising:
a binding manager to bind an application blueprint and an infrastructure blueprint to generate an aggregate blueprint based on the application blueprint and the infrastructure blueprint, the aggregate blueprint to enable the given application to utilize an instance of provisioned cloud resources specified by the infrastructure blueprint for lifecycle management on the cloud; and
a cloud service manager to manage a lifecycle of the given application and cloud infrastructure according to instructions contained in the aggregate blueprint; wherein the application blueprint characterizes a given application to enable lifecycle management of the given application on a cloud, and the infrastructure blueprint characterizes cloud infrastructure resources on the cloud and enable lifecycle management of the cloud infrastructure resources.

15. The system of claim 14, further comprising a monitor component to read feedback from the given application and enable the cloud service manager to adjust at least one of the given application or the cloud infrastructure.
